(19) United States
(12) Patent Application Publication
(10) Pub. No.: US 2007/0088552 A1
(43) Pub. Date: Apr. 19, 2007

(54) Method and a device for speech recognition

(75) Inventor: Jesper Olsen, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/252,475

(22) Filed: Oct. 17, 2005

(51) Int. Cl. G10L 15/14

(52) U.S. Cl. 704/256.2

(57) ABSTRACT

Method for speech recognition comprising inputting frames comprising samples of an audio signal; forming a feature vector comprising a first number of vector components for each frame; projecting the feature vector onto at least two subspaces so that the number of components of each projected feature vector is less than the first number and the total number of components of the projected feature vectors is the same as the first number; defining a set of mixture models for each projected vector which provides the highest observation probability; analysing the set of mixture models to determine the recognition result. When the recognition result is found, the method comprises determining a confidence measure for the recognition result, the determining comprising determining a probability that the recognition result is correct; determining a normalizing term; and dividing the probability by the normalizing term.

### FIELD OF THE INVENTION

The present invention relates to a method for speech recognition. The invention also relates to an electronic device and a computer program product.

### BACKGROUND OF THE INVENTION

Speech recognition is used in many applications, for example in name dialling in mobile terminals, access to corporate data over the telephone lines, multi-modal voice browsing of web pages, dictation of short messages (SMS), email messages etc.

In speech recognition one problem relates to converting a spoken utterance in the form of an acoustic waveform signal into a text string representing the spoken words. In practice this is very difficult to perform without recognition errors. Errors need not have serious consequences in an application if accurate confidence measures can be calculated, which indicate the probability that a given word or sentence has been misrecognised.

In speech recognition, errors are generally classified in three categories:

Insertion Error

The user says nothing but a command word is recognized in spite of this, or the user says a word which is not a command word and still a command word is recognized.

Deletion Error

The user says a command word but nothing is recognized.

Substitution Error

The command word uttered by the user is recognized as another command word.

In a theoretical optimum solution, the speech recognizer makes none of the above-mentioned errors. However, in practical situations, the speech recognizer may make errors of all the said types. For usability of the user interface, it is important to design the speech recognizer in a way that the relative shares of the different error types are optimal. For example in speech activation, where a speech-activated device waits even for hours for a certain activation word, it is important that the device is not erroneously activated at random. Furthermore, it is important that the command words uttered by the user are recognized at good accuracy. In this case, however, it is more important that no erroneous activations take place. In practice, this means that the user must repeat the uttered command word more often so that it would be recognized correctly at a sufficient probability.

In the recognition of a numerical sequence, almost all errors are equally significant. Any error in the recognition of the numbers in a sequence results in a false numerical sequence. Also the situation that the user says nothing and still a number is recognized, is inconvenient for the user. However, a situation in which the user utters a number indistinctly and the number is not recognized, can be corrected by the user by uttering the numbers more distinctly.

The recognition of a single command word is presently a very typical function implemented by speech recognition. For example, the speech recognizer may ask the user: “Do you want to receive a call?”, to which the user is expected to reply either “yes” or “no”. In such situations where there are very few alternative command words, the command words are often recognized correctly, if at all. In other words, the number of substitution errors in such a situation is very small. One problem in the recognition of single command words is that an uttered command is not recognized at all, or an irrelevant word is recognized as a command word.

Many existing automatic audio activity recognition systems (ASR) include a signal processing front-end that converts the audio activity waveform into feature parameters. One of the most used features is the Mel Frequency Cepstrum Coefficients (MFCC). Cepstrum is the Inverse Discrete Cosine Transform (IDCT) of the logarithm of the short-term power spectrum of the signal. One advantage of using such coefficients is that they reduce the dimension of an audio activity spectral vector.

Speech recognition usually relies on stochastic modelling of the speech signal—e.g. using Hidden Markov Models (HMM). In the HMM methods, an unknown speech pattern is compared with known reference patterns (pattern matching). In the HMM method, speech patterns are produced, and this stage of speech pattern generating is modelled with a state change model according to the Markov method. The state change model in question is thus the HMM. In this case, speech recognition on received speech patterns is performed by defining an observation probability on the speech patterns according to the Hidden Markov model. In speech recognition by using the HMM method, an HMM model is first formed for each word to be recognized, i.e. for each reference word. These HMM models are stored in the memory of the speech recognizer. When the speech recognizer receives the speech pattern, an observation probability is calculated for each HMM model in the memory, and as the recognition result, a counterpart word is obtained for the HMM model with the greatest observation probability. Thus for each reference word the probability is calculated that it is the word uttered by the user. The above-mentioned greatest observation probability describes the resemblance of the received speech pattern and the closest HMM model, i.e. the closest reference speech pattern. In other words, HMMs model a sequence of feature vectors as a piecewise stationary process for which each stationary segment will be associated with a specific HMM state. The feature vectors are typically formed a frame-by-frame basis of frames which are formed from an incoming audio signal. When using model M, an utterance O={O₁, . . . , O_{T}} is modelled as a succession of discrete stationary states S={S₁, . . . , S_{N}} (N≦T) with instantaneous transitions between these states.

Ideally, there should be a HMM for every possible utterance. However, this is usually infeasible for all but only some very constrained tasks. A sentence can be modelled as a sequence of words. To further reduce the number of parameters and to avoid the need of a new training each time a new word is added to the lexicon, word models are often comprised of concatenated sub-word units. The unit most commonly used are speech sounds (phones) that are acoustic realizations of the linguistic categories called phonemes. Phonemes are speech sound categories that are sufficient to differentiate between different words in a language. One or more HMM states are commonly used to model a segment corresponding to a phone. Word models consist of concatenations of phone or phoneme models (constrained by pronunciations from a lexicon), and sentence models consist of concatenations of word models (constrained by a grammar).

A speech recognizer performs pattern matching on an acoustic speech signal in order to compute the most likely word sequence. The likelihood score of an utterance is a by-product of the decoding, which itself indicates how reliable the match is. To be a useful confidence measure, the likelihood score needs to be compared to the likelihood score of all alternative competing utterances, e.g.:

$$Confidence = \frac{p ( O \text{\textbar} {s}_{1} ) P ( {s}_{1} )}{{\sum }_{s} p ( O \text{\textbar} s ) P ( s )} \qquad ( 1 )$$

in which O represents the acoustic signal, s₁ is a particular utterance, p(O|s₁) is the acoustic likelihood of utterance s₁, and P(s₁) is the prior probability of the utterance. The denominator in the above equation is a normalizing term, which represents the combined score of any utterance that could have been spoken (including s₁). In practice, the normalizing term can not be computed directly, because of the number of utterances over which one has to do the summation is infinite.

However, the normalizing term can be approximated e.g. by training a special text independent speech model, and using the likelihood score obtained by decoding the speech utterance with that model as the normalizing term. If the speech model is sufficiently complex and well trained, the likelihood score is expected to be a good approximation of the denominator in Equation (1).

The drawback of the above approach to confidence estimation is that a special speech model has to be used for decoding the speech. This represents a computational overhead in the decoding process since the computed normalizing term has no bearing on which utterance is chosen by the recognizer as the most probable one. It is only needed for the confidence score evaluation.

Alternatively the approximation can be based on Gaussian mixtures that are evaluated in the model set—irrespective to which words they are a part. This is an easier approximation since no extra Gaussian mixtures have to be evaluated. The disadvantage is that the Gaussian mixtures which are evaluated may belong to a very small subset of the Gaussian mixtures in the model set, and hence the approximation will be biased and inaccurate.

An acoustic model set, e.g. Hidden Markov Models, for a large vocabulary task may typically contain 25,000-100,000 Gaussian mixtures. The HMM likelihoods can be calculated by summation of these individual Gaussian mixture likelihoods N(o,m,σ²)=exp((x−m)²/o²) in which o is an observation vector of dimension D, m is a mean vector, and σ is a variance vector.

### SUMMARY OF THE INVENTION

The present invention provides speech recognition arrangement in which an approximation of the normalizing term in Equation (1) is evaluated and utilized. The approximation is possible when using the so called subspace Hidden Markov Models (subspace HMMs) for acoustic modelling. The subspace Hidden Markov Models are disclosed in more detail in the publication “Subspace Distribution Clustering Hidden Markov Model”, Enrico Bocchieri and Brian Mak, IEEE Transactions on Speech And Audio Processing, Vol. 9, No. 3, March 2001.

According to a first aspect of the present invention there is provided a method for speech recognition comprising:
inputting frames comprising samples of an audio signal;
forming a feature vector comprising a first number of vector components for each frame;
projecting the feature vector onto at least two subspaces so that the number of components of each projected feature vector is less than the first number and the total number of components of the projected feature vectors is the same as the first number;
defining a set of mixture models for each projected vector which provides the highest observation probability;
analysing the set of mixture models to determine the recognition result;
when the recognition result is found, determining a confidence measure for the recognition result, the determining comprising:
   determining a probability that the recognition result is correct;
   determining a normalizing term by selecting, for each state, one mixture model among said set of mixture models, which provides the highest likelihood; and
   dividing the probability by said normalizing term;

wherein the method further comprises comparing the confidence measure to a threshold value to determine whether the recognition result is reliable enough.

According to a second aspect of the present invention there is provided an electronic device comprising:
an input for inputting audio signal;
an analog-to-digital converter for forming samples from the audio signal;
an organizer for arranging the samples of the audio signal into frames;
a feature extractor for forming a feature vector comprising a first number of vector components for each frame and for projecting the feature vector onto at least two subspaces so that the number of components of each projected feature vector is less than the first number and the total number of components of the projected feature vectors is the same as the first number;
a probability calculator for defining a set of mixture models for each projected vector which provides the highest observation probability and analysing the set of mixture models to determine the recognition result;
a confidence determinator for determining a confidence measure for the recognition result, the determining comprising:
   determining a probability that the recognition result is correct;
   determining a normalizing term by selecting, for each state, one mixture model among said set of mixture models, which provides the highest likelihood; and
   dividing the probability by said normalizing term;

a comparator for comparing the confidence measure to a threshold value to determine whether the recognition result is reliable enough.

According to a third aspect of the present invention there is provided a computer program product comprising machine executable steps for performing speech recognition comprising:
inputting frames comprising samples of an audio signal;
forming a feature vector comprising a first number of vector components for each frame;
projecting the feature vector onto at least two subspaces so that the number of components of each projected feature vector is less than the first number and the total number of components of the projected feature vectors is the same as the first number;
defining a set of mixture models for each projected vector which provides the highest observation probability;
analysing the set of mixture models to determine the recognition result;
when the recognition result is found, determining a confidence measure for the recognition result, the determining comprising:
   determining a probability that the recognition result is correct;
   determining a normalizing term by selecting, for each state, one mixture model among said set of mixture models, which provides the highest likelihood; and
   dividing the probability by said normalizing term;

wherein the computer program product further comprises machine executable steps for comparing the confidence measure to a threshold value to determine whether the recognition result is reliable enough.

When using the present invention the reliability of the speech recognition may be improved when compared with prior art methods and speech recognizers. Also the memory requirements for storing the reference patterns are smaller when compared to speech recognizers in which more reference patterns are needed. The speech recognition method of the present invention may also perform the speech recognition faster than speech recognition methods of prior art.

### DESCRIPTION OF THE DRAWINGS

In the following, the invention will be described in more detail with reference to the appended drawings, in which

FIG. 1 illustrates a wireless communication device according to an example embodiment of the invention in a reduced schematic diagram, and

FIG. 2 shows a method according to an example embodiment of the invention as a flow diagram.

### DETAILED DESCRIPTION OF THE INVENTION

In the following, some theoretical background of subspace HMMs which are used in the method of the present invention will be disclosed. Subspace HMMs are characterized by a more compact model representation compared to ordinary HMMs. This is achieved by clustering the feature vector components of a D-dimensional feature vector in a number of subspaces (n). For n=1 (one subspace of dimension D), the subspace HMM model generalizes to the ordinary HMM model in a D-dimensional feature space. The maximum number of subspaces is the same as the dimensionality of the original feature space (D), in which case each subspace has dimension 1.

The subspace representation makes it possible to quantise the subspaces using relatively small codebooks—e.g. codebooks with 16-256 elements per subspace. Each mixture is then represented by indices (m₁, . . . , m_{N}) to codewords in the N subspace codebooks. This representation has two consequences. First, the model set can be represented in a very compact form, and second, the likelihood computations for the mixtures in each HMM state can be computed more efficiently (faster) by precomputing and sharing intermediate results.

The present invention is mainly based on the second property mentioned above. For an observed feature vector, O, the likelihood of a Gaussian mixture (m₁, . . . , m_{N}) is computed as follows:

$$p ( O ) = {\prod }_{k = 1}^{K} {N}^{tied} ( {O}_{k} , {μ}_{smk} , {σ}_{smk}^{2} ) \qquad ( 2 )$$

In the equation (2) above a diagonal covariance was assumed. The first product with index k of the equation (2) is calculated over the number of subspaces (K) and the second product with index d (1, . . . , N) is calculated over the individual feature components inside a subspace. The terms Oₖ, μₛₘₖ and σ²smk are the projection of the observed feature vector, a mean and a variance vector of the m^{th} mixture component of the s^{th} state onto the k^{th} stream, respectively. The term N( ) is the Gaussian probability density function of state s. Because the subspace codebooks are relatively small, the term N^{tied} (Oₖ, μₖₘₖ, σ²kmk) can be precomputed and cached before evaluating the individual mixture likelihoods. This is what makes the evaluation of mixture likelihoods in a subspace HMM model set faster than in an ordinary model set.

As was already mentioned in this description the confidence measure indicates the probability that a given word or sentence has been misrecognized. Therefore, the confidence measure should be calculated to evaluate whether the recognition result is reliable enough or not. In this invention the confidence measure is based on the subspace cache which is computed anyway when using subspace HMMs.

The normalizing term of equation (1) for the utterance is computed as

$$p ( {O}_{1} , … , {O}_{T} ) = {\prod }_{t = 1}^{T} {\prod }_{k = 1}^{K} max ( {N}^{tied} ( {O}_{k} , {μ}_{smk} , {σ}_{smk}^{2} ) ) \qquad ( 3 )$$

This normalizing term corresponds to an HMM model with a number of states (s) equal to the number of frames (T) in the audio signal under consideration, and one mixture component per state. The mixture component m has the highest possible likelihood in the model set given subspace partitioning. The mixtures in this special HMM may not actually occur in any of the other HMMs in the model set, and consequently the normalizing term is always a likelihood that is higher than or equal to the likelihood of any given utterance. In other words, the normalizing term is an approximation of a much more expensive computation, in which the following steps are performed for each frame: The highest scoring mixture is identified which means that if there are e.g. 25,000 mixtures, 25,000 likelihood computations need to be performed in order to find the highest scoring mixture. When the subspace HMMs are used, the normalizing term of equation (3) can be calculated much faster because the calculation time does not depend on the number of mixtures. It only depends on the number of streams (K in equation 3) and the size of the codebooks used. For example, if 39 1-dimensional streams were formed and a 32 element codebook were used for each stream, then one mixture likelihood is evaluated for each codebook which means that only 32 mixture likelihoods need to be evaluated.

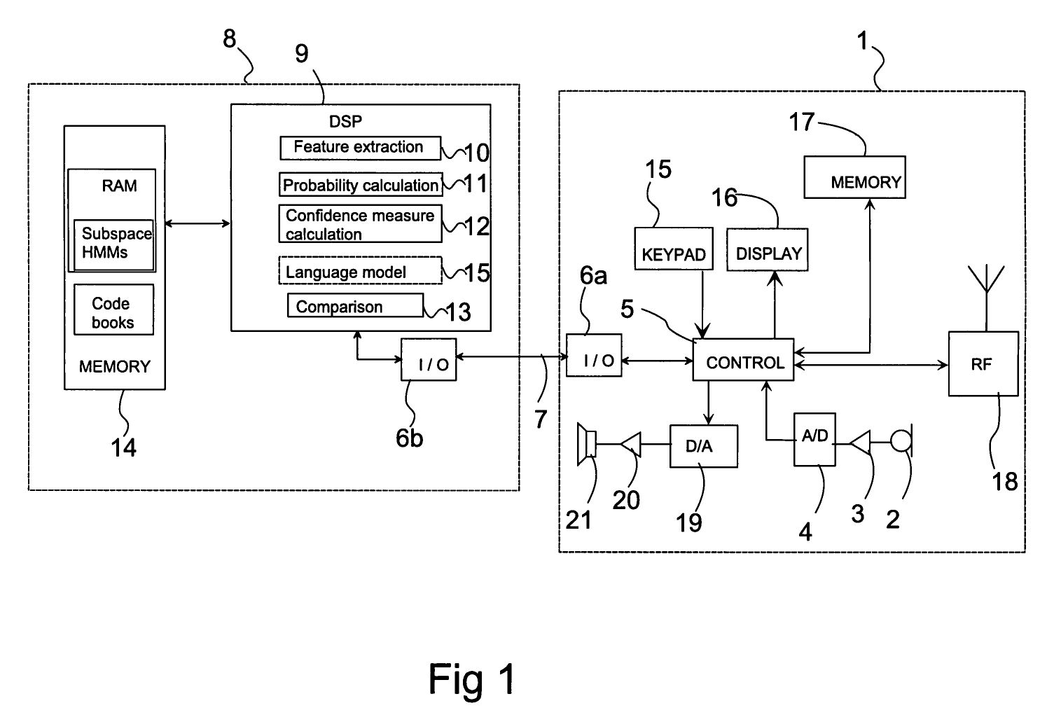

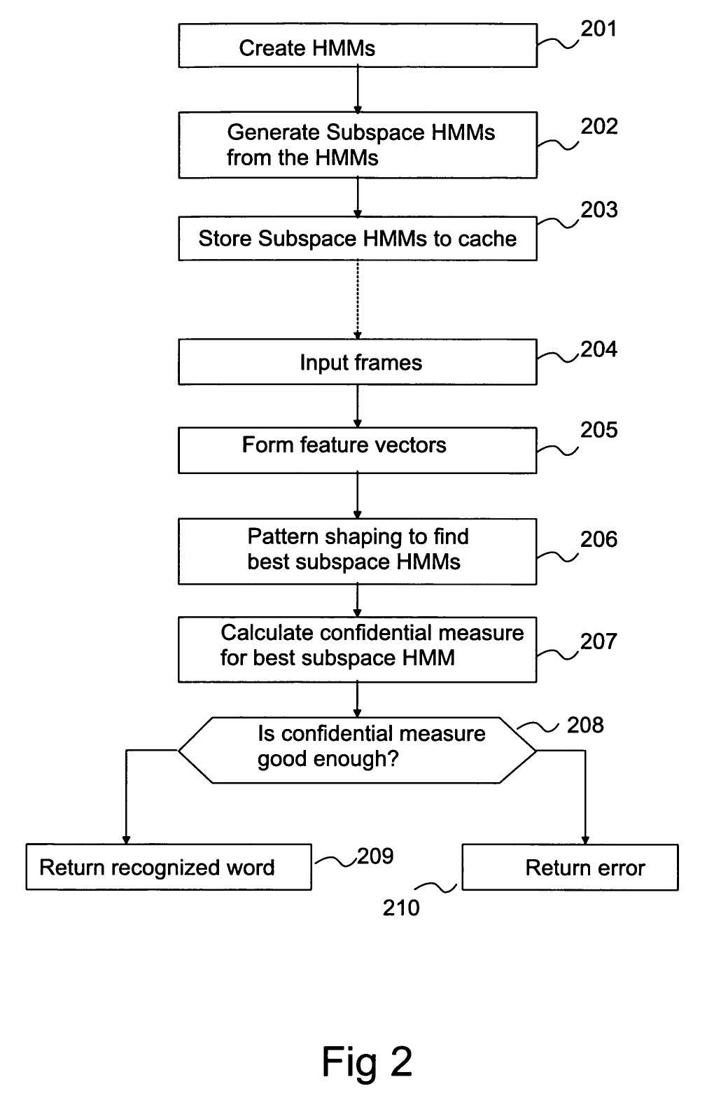

In the following, the function of the speech recognizer 8 according to an advantageous embodiment of the invention will be described in more detail with reference to the electronic device 1 of FIG. 1 and the flow diagram of FIG. 2. The speech recognizer 8 is connected to the electronic device 1 such as a wireless communication device but it is obvious that the speech recognizer 8 can be a part of the electronic device 1 wherein some operational blocks may be common to both the speech recognizer 8 and the electronic device 1. The speech recogniser 8 can also be implemented as a module which can either be externally or internally connected with the electronic device 1. The electronic device 1 is not necessarily a wireless communication device but it can also be a computer, a lock, a TV, a toy, etc. in which the speech recognition property can be utilized.

To enable the speech recognition in the speech recogniser 8 an HMM model has been formed 201 for each word to be recognized, i.e. for each reference word. They can be formed for example by training the speech recogniser 8 with a certain training material. Also subspace HMM models are formed 202 on the basis of these HMM models. In an example implementation of the present invention the N-stream subspace HMMs can be derived so that the D-dimensional feature space is partitioned into N subsets with dₖ features in such a way that

$${\sum }_{k = 1}^{n} {d}_{k} = D .$$

Each of the original Gaussian mixtures are projected onto each feature subspace to obtain n subspace Gaussian mixtures. The resulting subspace HMM models are quantised e.g. by using codebooks and the quantised HMM models are stored 203 in the memory 14 of the speech recognizer 8.

To perform the speech recognition, an acoustic signal (audio signal, speech) is converted, in a way known as such, into an electrical signal by a microphone, such as a microphone 2 of the wireless communication device 1. The frequency response of the speech signal is typically limited to the frequency range below 10 kHz, e.g. in the frequency range from 100 Hz to 10 kHz but the invention is not only limited to such frequency range. However, the frequency response of speech is not constant in the whole frequency range but there are typically more lower frequencies than higher frequencies. Furthermore, the frequency response of speech is different for different persons.

The electrical signal generated by the microphone 2 is amplified in the amplifier 3 when necessary. The amplified signal is converted into digital form by the analog/digital converter 4 (ADC). The analog/digital converter 4 forms samples representing the amplitude of the signal at the sampling moment. The analog/digital converter 4 usually forms samples from the signal at certain intervals i.e. at a certain sampling rate. The signal is divided into speech frames which means that a certain length of the audio signal is processed at one time. The length of the frame is usually a few milliseconds, for example 20 ms. In this example embodiment the frames are transferred to the speech recognizer 8 via the I/O blocks 6a, 6b and the interface bus 7.

The speech recogniser 8 has also a speech processor 9 in which the calculations for the speech recognition are performed. The speech processor 9 is, for example, a digital signal processor (DSP).

The samples of the audio signal are input 204 to the speech processor 9. In the speech processor 9 the samples are processed on a frame-by-frame basis i.e. each sample of one frame are processed to perform a feature extraction on the speech frame. In the feature extraction step 205 a feature vector is formed for each speech frame which is input to the speech recognizer 8. The coefficients of the feature vector relate to some sort of spectrally based features of the frame. The feature vectors are formed in a feature extraction block 10 of the speech processor by using the samples of the audio signal. This feature extraction block 10 can be implemented e.g. as a set of filters each having a certain bandwidth. All the filters cover the whole bandwidth of the audio signal. The bandwidths of the filters may partly overlap with some other filters of the feature extraction block 10. The outputs of the filters are transformed, such as discrete cosine transformed (DCT), wherein the result of the transformation is the feature vector. In this example embodiment of the present invention the feature vectors are 39-dimensional vectors but it is obvious that the invention is not limited to such vectors only. In this example embodiment the feature vectors are Mel Frequency Cepstrum Coefficients. The 39-dimensional vectors thus comprise 39 features: 12 MFCCs, normalized power, and their first- and second-order time derivatives (12+1+13+13=39).

In the speech processor 9 an observation probability is calculated e.g. in the probability calculation block 11 for each HMM model in the memory using the feature vectors, and as the recognition result, a counterpart word is obtained 206 for the HMM model with the greatest observation probability. Thus, for each reference word the probability is calculated that it is the word uttered by the user. The above-mentioned greatest observation probability describes the resemblance of the received speech pattern and the closest HMM model, i.e. the closest reference speech pattern.

When the counterpart word (or words) is/are found, the confidence measure calculation block 12 of the speech processor 9 calculates 207 the confidence measure for the counterpart word to evaluate the reliability of the recognition result. The confidence measure is calculated by the equation (1) in which the denominator is replaced with the equation (3):

$$confidence = \frac{p ( O \text{\textbar} {s}_{1} ) P ( {s}_{1} )}{{\prod }_{t = 1}^{T} {\prod }_{k = 1}^{K} max ( {N}^{tied} ( {O}_{k} , {μ}_{smk} , {σ}_{smk}^{2} ) )} \qquad ( 4 )$$

The calculated confidence can then be compared 208 with a threshold value e.g. in the comparator block 13 of the speech processor 9. If the comparison indicates that the confidence is high enough the recognition result i.e. the counterpart word(s) can then be used as the recognition result 209 of the utterance. The counterpart word(s) or an indication (e.g. an index to a table) of the counterpart word(s) is/are transferred to the wireless communication device 1 in which e.g. the control block 5 determines operations which need to be performed on the basis of the counterpart word. The counterpart word may be a command word wherein a command respective to the counterpart word is performed. The command may be, for example, answer a call, dial a number, start an application, write a short message, etc.

In a situation that the comparison indicated a too low value, it is determined that the recognition result may not be reliable enough. In that case the speech processor 9 may inform 210 the wireless communication device 1 that the recognition was not successful and the user may be asked to repeat the utterance, for example.

The speech processor 9 may also use a language model in determining the uttered word. The language model may be useful especially when the calculated observation probabilities indicate that two or more words could be uttered. The reason for that is, for example, that the utterances of such two or more words are almost identical. Then, the language model may indicate which of the words would be the best suitable word in that particular context. For example the pronunciations of the words “too” and “two” are very near with each other, wherein the context may indicate which one is the correct word.

The present invention can be largely implemented as a software, for example as machine executable steps for the speech processor 9 and/or the control block 5.

What is claimed is:

1. A method for speech recognition comprising:
inputting frames comprising samples of an audio signal;
forming a feature vector comprising a first number of vector components for each frame;
projecting the feature vector onto at least two subspaces so that the number of components of each projected feature vector is less than the first number and the total number of components of the projected feature vectors is the same as the first number;
defining a set of mixture models for each projected vector which provides the highest observation probability;
analysing the set of mixture models to determine the recognition result;
when the recognition result is found, determining a confidence measure for the recognition result, the determining comprising:
determining a probability that the recognition result is correct;
determining a normalizing term by selecting, for each state, one mixture model among said set of mixture models, which provides the highest likelihood; and
dividing the probability by said normalizing term;
wherein the method further comprises comparing the confidence measure to a threshold value to determine whether the recognition result is reliable enough.

2. The method according to claim 1, wherein the confidence measure is calculated by the following equation:
$$confidence = \frac{p ( O \text{\textbar} {s}_{1} ) P ( {s}_{1} )}{{\prod }_{t = 1}^{T} {\prod }_{k = 1}^{K} max ( {N}^{tied} ( {O}_{k} , {μ}_{smk} , {σ}_{smk}^{2} ) )}$$
in which
O is the feature vector of said acoustic signal;
s₁ is a particular utterance of said acoustic signal;
p(O|s₁) is the acoustic likelihood of said particular utterance s₁;
P(s₁) is the prior probability of said particular utterance;
Oₖ is the projection of the feature vector onto the k^{th} subspace;
μₛₘₖ is the mean of the m^{th} mixture component of the s^{th} state onto the k^{th} subspace;
σ²smk is the variance vector of the m^{th} mixture component of the s^{th} state onto the k^{th} subspace;
N( ) is the Gaussian probability density function of state s;
K is the number of subspaces; and
T is the number or frames in said acoustic signal.

3. The method according to claim 1, wherein each subspace is represented by a codebook wherein the mixture models are indicated by an index to the codebook.

4. The method according to claim 1, wherein the feature vectors are formed by determining Mel Frequency Cepstrum Coefficients for each frame.

5. An electronic device comprising:
an input for inputting audio signal;
an analog-to-digital converter for forming samples from the audio signal;
an organizer for arranging the samples of the audio signal into frames;
a feature extractor for forming a feature vector comprising a first number of vector components for each frame and for projecting the feature vector onto at least two subspaces so that the number of components of each projected feature vector is less than the first number and the total number of components of the projected feature vectors is the same as the first number;
a probability calculator for defining a set of mixture models for each projected vector which provides the highest observation probability and analysing the set of mixture models to determine the recognition result;
a confidence determinator for determining a confidence measure for the recognition result, the determining comprising:
determining a probability that the recognition result is correct;
determining a normalizing term by selecting, for each state, one mixture model among said set of mixture models, which provides the highest likelihood; and
dividing the probability by said normalizing term;
a comparator for comparing the confidence measure to a threshold value to determine whether the recognition result is reliable enough.

6. The electronic device according to claim 5 further comprising a codebook for each subspace.

7. The electronic device according to claim 6, wherein the mixture models are indicated by an index to the codebook.

8. The electronic device according to claim 5, wherein the feature extractor comprises means for forming the feature vectors by determining Mel Frequency Cepstrum Coefficients for each frame.

9. The electronic device according to claim 5, wherein it is a wireless terminal.

10. The electronic device according to claim 5, wherein it is a speech recognition device.

11. A computer program product comprising machine executable steps stored on a readable medium for execution on a processor, the machine executable steps, when executed by the processor, for speech recognition, comprising:
inputting frames comprising samples of an audio signal;
forming a feature vector comprising a first number of vector components for each frame;
projecting the feature vector onto at least two subspaces so that the number of components of each projected feature vector is less than the first number and the total number of components of the projected feature vectors is the same as the first number;
defining a set of mixture models for each projected vector which provides the highest observation probability;
analysing the set of mixture models to determine the recognition result;
when the recognition result is found, determining a confidence measure for the recognition result, the determining comprising:
determining a probability that the recognition result is correct;
determining a normalizing term by selecting, for each state, one mixture model among said set of mixture models, which provides the highest likelihood; and
dividing the probability by said normalizing term;
wherein the computer program product further comprises machine executable steps for comparing the confidence measure to a threshold value to determine whether the recognition result is reliable enough.

12. The computer program product according to claim 11, wherein said determining a confidence measure for the recognition result comprises machine executable steps for calculating the confidence measure by the following equation:
$$confidence = \frac{p ( O \text{\textbar} {s}_{1} ) P ( {s}_{1} )}{{\prod }_{t = 1}^{T} {\prod }_{k = 1}^{K} max ( {N}^{tied} ( {O}_{k} , {μ}_{smk} , {σ}_{smk}^{2} ) )}$$
in which
O is the feature vector of said acoustic signal;
s₁ is a particular utterance of said acoustic signal;
p(O|s₁) is the acoustic likelihood of said particular utterance s₁;
P(s₁) is the prior probability of said particular utterance;
Oₖ is the projection of the feature vector onto the k^{th} subspace;
μₛₘₖ is the mean of the m^{th} mixture component of the s^{th} state onto the k^{th} subspace;
σ²smk is the variance vector of the m^{th} mixture component of the s^{th} state onto the k^{th} subspace;
N( ) is the Gaussian probability density function of state s;
K is the number of subspaces; and
T is the number or frames in said acoustic signal.

13. The computer program product according to claim 11 comprising machine executable steps for representing each subspace by a codebook and for indicating the mixture models by an index to the codebook.

14. The computer program product according to claim 11 comprising machine executable steps for forming the feature vectors by determining Mel Frequency Cepstrum Coefficients for each frame.
